(19) United States
(12) Patent Application Publication
(10) Pub. No.: US 2016/0321907 A1
(43) Pub. Date: Nov. 3, 2016

(54) OBJECT LOCATING SYSTEM

(71) Applicant: Shakirah Smith, Harrisburg, PA (US)

(72) Inventor: Shakirah Smith, Harrisburg, PA (US)

(21) Appl. No.: 14/701,819

(22) Filed: May 1, 2015

(51) Int. Cl. G08B 21/24

(52) U.S. Cl. CPC G08B 21/24

(57) ABSTRACT

A system for object locating including: at least one object card; a unique identifier for each object card; a transmitter on each object card; a unique locating signal associated with each unique identifier emitted from each respective transmitter; and a means to attach on each object card. In one particular embodiment, the unique identifier may be a numerical code. The means to attach may include an adhesive or a hook and loop connector. In one exemplary embodiment, the unique locating signal is a RF signal or a GPS locating signal.

### BACKGROUND OF THE INVENTION

1. Field of Invention

The present invention relates to a locating system to assist individuals in locating objects.

2. Description of Related Art

Individuals frequently have trouble misplacing objects in a normal course of a day. Many times individuals must keep aware of various items such as keys, mobile phones, remote controls, glasses, jewelry or other items. Throughout the day occasionally objects may be misplaced therefore an individual will have to spend time searching for items that have been misplaced. As a consequence, it would be advantageous to have a system that included the means to locate a lost item through a tracking device.

### SUMMARY OF THE INVENTION

The present invention relates to a system for object locating comprising: at least one object card; a unique identifier for each object card; a transmitter on each object card; a unique locating signal associated with each unique identifier emitted from each respective transmitter; and a means to attach on each object card. In one particular embodiment, the unique identifier may be a numerical code. The means to attach may include an adhesive or a hook and loop connector. In one exemplary embodiment, the unique locating signal is a RF signal or a GPS locating signal.

### BRIEF DESCRIPTION OF DRAWINGS

FIG. 1 depicts an attachable card that may be used within the system of the present invention.

FIG. 2 depicts a second embodiment of an attachable card used within the system of the present invention.

### DETAILED DESCRIPTION

The present invention provides a system in the form of at least one card and a wireless transmission to a receiver for locating of objects. In particular, the present invention includes an attachable card that is attached to an object such as a cell phone, keys, glasses or other usually misplaced items. The system includes an adhesive or attachment means on a first side of the card and an identifying number associated with the card on a second side of the card. A transmitter provided on the card that transmits a signal to a receiver that provides an indication of the location of the misplaced item.

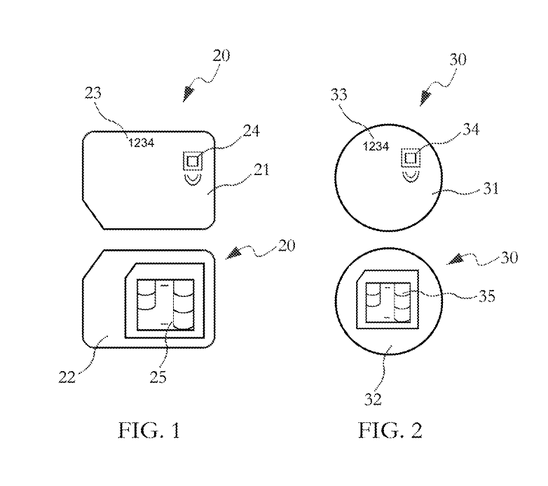

In reference to FIG. 1, a first attachable transmitting card 20 is depicted. The card 20 includes a digital identifying number 23 and a transmitter 24 on a front side 21 of the card 20. A receiver uses this identifying number 23 so that a user may identify a signal provided by the transmitter 24. The transmitting signal 24 is unique to the transmitting card 20. As a result, a plurality of cards 20 may be used with distinct identifying numbers 23. These identifying numbers 23 are distinct for each card and as a result multiple cards may be used on various objects by user. FIG. 1 also depicts a rear side 22 of the card 20. This rear side 22 includes an attachment means 25 to attach the card 20 to a particular object. This attachment means 25 may be in the form of adhesive or in the form of hook and loop connectors that attach to the adjoining hook and loop connectors provided on the object.

The card 20 is a substantial rectangular card as shown in FIG. 1. A second embodiment is shown in FIG. 2 that depicts a substantially circular card 30. This card 30 further includes an identifying number 33 with transmitter 34. A front surface 31 is provided for the card 30, which depicts the identifying number 33. On the rear side 32 is provided an attachment means 35. The attachment means 35 may include an adhesive or hook and loop connectors to adhere the card 30 to an object.

During use this system may utilize multiple cards in the form as depicted in FIGS. 1 and 2. The multiple cards may be attached to various objects and therefore capable of locating multiple objects as needed. A receiver is used, not shown, that receives the signal transmitted by each respective transmitter provided on each card of the system. This transmitter may transmit in the form of a RF signal and use locating logic in the form of GPS tracking system. Each card of the system may be implemented into a receiver, where an alert is provided if a certain amount of distance is created between the card and receiver therefore alerting the user that an item has been left beyond a predetermined distance. The instant invention has been shown and described in what it considers to be the most practical and preferred embodiments. It is recognized, however, that departures may be made there from within the scope of the invention and that obvious modifications will occur to a person skilled in the art.

1. A system for object locating comprising:
a. at least one object card;
b. a unique identifier for each object card;
c. a transmitter on each object card;
d. a unique locating signal associated with each unique identifier emitted from each respective transmitter; and
e. a means to removably attach on each object card.

2. The system according to claim 1, where the unique identifier is a numerical code.

3. The system according to claim 1, where the means to attach includes an adhesive or a hook and loop connector.

4. The system according where the unique locating signal is a RF signal.

5. The system according to claim 1, where the locating signal is a GPS locating signal.
